(19) United States
(12) Patent Application Publication
(10) Pub. No.: US 2017/0322998 A1
(43) Pub. Date: Nov. 9, 2017

(54) INFORMATION PROCESSING DEVICE, INFORMATION PROCESSING METHOD, AND COMPUTER-READABLE STORAGE MEDIUM

(71) Applicant: NEC Solution Innovators, Ltd., Koto-ku, Tokyo (JP)

(72) Inventors: Yuzuru OKAJIMA, Tokyo (JP); Kouichi MARUYAMA, Tokyo (JP)

(73) Assignee: NEC Solution Innovators, Ltd., Koto-ku, Tokyo (JP)

(21) Appl. No.: 15/523,708

(22) PCT Filed: Oct. 19, 2015
(86) PCT No.: PCT/JP2015/079476

§ 371 Date: May 2, 2017

(30) Foreign Application Priority Data
Nov. 7, 2014 (JP) 2014-227041

(51) Int. Cl. G06F 17/30

(52) U.S. Cl. CPC G06F 17/30592; G06F 17/30536

(57) ABSTRACT

An information processing device (100) processes a data structure that expresses a set of points that are included in a multidimensional space, and includes: an interval search unit (10) that, when a particular multidimensional region is specified as a query region, specifies an interval that is included in a sequence of points that is obtained from a set of points, and that is composed of only points whose coordinates with respect to dimensions other than one dimension are included in the query region; an aggregation unit (20) that specifies a range of coordinate values with respect to the one dimension, as a condition for a point that appears in the interval to be included in the query region; and a coordinate sequence aggregation unit (30) that receives the specified interval and the range of a coordinate value, and, with respect to a coordinate sequence that is obtained by taking out coordinates of the set of points with respect to the one dimension, and with respect to all coordinates that appear in the input interval and whose values are included in the input range, calculates a statistical amount regarding a set of points to which the coordinates correspond.

### TECHNICAL FIELD

The present invention relates to an information processing device, an information processing method, and a computer-readable storage medium that stores programs for realizing the device and the method, and particularly to an information processing device, an information processing method, and a computer-readable storage medium for efficiently performing a search through multidimensional data.

Finding points that are included in a specified rectangular range when there are numerous points in a multidimensional space is called “orthogonal range search”. For example, when d denotes the number of dimensions, points that exist in a multidimensional space having d dimensions can be expressed by p=(p₁, p₂, . . . , p_{d}), using a combination of d coordinates. It is assumed that a set of points in such a multidimensional space is provided in advance. It is also assumed that each point p is given a weight w(p).

Here, a range with respect to each dimension k is expressed by [l_{qk}, u_{qk}], and a d-dimensional rectangular range expressed by Q=[l_{q1}, u_{q1}]×[l_{q2}, u_{q2}]× . . . ×[l_{qd}, u_{qd}] is considered. This rectangular range is referred to as a query region, and the aim of the orthogonal range search is to search for points p that are included in this query region Q, namely a set of points p that satisfy ∀kε{1, . . . , d}: l_{qk}≦pₖ≦u_{qk}, and to calculate information regarding the set. Here, d conditions ∀kε{1, . . . , d}: l_{qk}≦pₖ≦u_{qk} for a point p to be included in the query region Q are each referred to as “a range condition” of the query.

Such an orthogonal range search plays an important role in applications that handle geographical information, and also in multidimensional data analysis. The following shows specific examples.

For example, the position of a restaurant on a map can be expressed by two-dimensional data “(latitude, longitude)” that is a combination of two values. In this case, by using the orthogonal range search, it is possible to search for all of the restaurants whose latitude is within the range of 138 degrees to 139 degrees and whose longitude is within the range of 35 degrees to 36 degrees.

Also, for example, it is possible to express statistical data regarding employees of a company by using three-dimensional data “(age, body height, annual income)”. In this case, by using the orthogonal range search, it is possible to search for all of the employees whose age is within the range of 30 to 40, whose body height is within the range of 170 cm to 180 cm, and whose annual income is within the range of five million yen to six million yen.

Furthermore, there are various variations of an orthogonal range search, which are different in what search results are returned. A report query and an aggregate query are examples of these variations.

First, the report query is an orthogonal range search that returns a list of all of the points that are included in the query region. The number of points that are included in the query region is referred to as a hit count. The report query returns a list having a size that is proportional to the hit count, and therefore the report query is not suitable for analyzing large-scale data for which the hit count is expected to be large. For example, when tens of millions of points are included, the report query outputs all of the tens of millions of points.

Therefore, in cases of large-scale data analysis, the aggregate query that returns the results of aggregation of these points is more important compared to returning a list of all of the points included in the query region. The most representative query among various kinds of aggregate queries is a count query.

The count query is a kind of orthogonal range search that returns the number of points included in the query region. In addition to the count query, when a weight is given to each point, there are, for example: a sum query that returns the sum of the weights of the points that are included in the query region; and a max query that returns the maximum value of the weights.

In the present specification, information that is returned by such queries is collectively referred to as “the statistical amount”. Examples of the statistical amount include a count and a sum. Also, a statistical amount regarding a subset of points included in a query is referred to as “a partial statistical amount”, and a statistical amount regarding all of the set of points included in a query is referred to as “an overall statistical amount”.

A k-d tree is known as a representative data structure that can be used for orthogonal range search (for example, see Non-Patent Document 1). The size of a k-d tree can be expressed by O(n), i.e. a linear size. Also, it is known that the worst time complexity of an orthogonal range search using a k-d tree is O(n^{(d-1)/d}). Note that n denotes the number of data sets, and d denotes the number of dimensions. The worst time complexity O(n^{(d-1)/d}) achieved by using a k-d tree is the best one among the time complexities of conventionally known data structures having a practical linear size.

If an orthogonal range search is applied to a data structure having a super-linear size that is greater than O(n), it is possible to improve the computation time (the time complexity). An example of a data structure having such a super-linear size is a data structure that is called “range tree”.

An orthogonal range search can also be realized by using a two-dimensional data structure that is called “wavelet tree” (for example, see Non-Patent Document 1). If this is the case, a search is performed within a two-dimensional space, and the time complexity is O(log n).

Note that the details of the above-described orthogonal range search using a k-d tree and a wavelet tree are described in the Non-Patent Document 1. Also, the details of an approach to calculate a statistical amount in a two-dimensional space by using a wavelet tree are described in the Non-Patent Document 2.

### CITATION LIST

### Non-Patent Documents

Non-Patent Document 1: Meng He, “Succinct and Implicit Data Structures for Computational Geometry”, Lecture Notes in Computer Science Volume 8066 “Space-Efficient Data Structures, Streams, and Algorithms”, pp 216-235, 2013, Springer Berlin Heidelberg, ISBN 978-3-642-40272-2

Non-Patent Document 2: Gonzalo Navarro and Luis M. S. Russo. “Space-efficient data-analysis queries on grids”, In Proceedings of the 22nd International Conference on Algorithms and Computation, ISAAC′11, pp. 323-332, Berlin, Heidelberg, 2011. Springer-Verlag.

### DISCLOSURE OF THE INVENTION

### Problems to be Solved by the Invention

In this way, various data structures are available to realize the orthogonal range search. However, in practice, there are the following problems. First, in the case where orthogonal range search is realized by using a k-d tree, there is a problem in which the achievable worst time complexity O(n^{(d-1)/d}) increases along with an increase in either one or both of n, which denotes the number of data sets, and d, which denotes the number of dimensions.

Also, if orthogonal range search is realized by using a data structure having a super-linear size, although it is possible to improve the computation time compared to the case where orthogonal range search is realized by using a k-d tree, there is a problem in which the data structure having the super-linear size is too large in size, and therefore it is difficult and impractical to use the data structure in an actual application.

Furthermore, if orthogonal range search is realized by using a wavelet tree, since a wavelet tree is only applicable to two-dimensional data, there is a problem in which it is impossible to perform a search through a data structure having a desired number of dimensions that is greater than or equal to three.

One example of aims of the present invention is to solve the above-described problems and to provide an information processing device, an information processing method, and a computer-readable storage medium that can realize orthogonal range search with respect to a desired dimension at a higher speed compared to cases of k-d trees, by using a data structure having a linear size.

### Means for Solving the Problems

To achieve the above-described aim, an information processing device according to one aspect of the present invention provides an information processing device that processes a data structure that expresses a set of points that are included in a multidimensional space, comprising:

an interval search unit that, when a particular multidimensional region is specified as a query region, specifies an interval that is included in a sequence of points that is obtained by arranging the set of points in a sequence, and that is composed of only points whose coordinates with respect to dimensions other than one dimension, out of all dimensions that constitute the multidimensional space, are included in the query region;

an aggregation unit that specifies, with respect to the interval specified by the interval search unit, a range of coordinate values with respect to the one dimension, as a condition for a point that appears in the interval to be included in the query region; and

a coordinate sequence aggregation unit that receives the interval specified by the interval search unit and the range of a coordinate value specified by the aggregation unit, and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculates a statistical amount regarding a set of points to which the coordinates correspond.

Also, to achieve the above-described aim, an information processing method according to one aspect of the present invention provides an information processing method for processing a data structure that expresses a set of points that are included in a multidimensional space, comprising:

(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;

(b) a step of specifying, with respect to the interval specified in the step (a), a range of coordinate values with respect to the one dimension, as a condition for a point that appears in the interval to be included in the query region; and

(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculating a statistical amount regarding a set of points to which the coordinates correspond.

Furthermore, to achieve the above-described aim, a computer-readable storage medium according to one aspect of the present invention provides a computer-readable storage medium that stores a program for executing information processing to process a data structure that expresses a set of points that are included in a multidimensional space by using a computer, the program including an instruction that causes the computer to execute:

(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;

(b) a step of specifying, with respect to the interval specified in the step (a), a range of coordinate values with respect to the one dimension, as a condition for a point that appears in the interval to be included in the query region; and

(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all of coordinates that appear in the input interval in the coordinate sequence and whose values are included in the input range, calculating a statistical amount regarding a set of points to which the coordinates correspond.

### Effects of the Invention

As described above, according to the present invention, it is possible to realize orthogonal range search with respect to a desired dimension at a higher speed compared to cases of k-d trees, by using a data structure having a linear size.

### BRIEF DESCRIPTION OF THE DRAWINGS

FIG. 1 is a block diagram showing an overall configuration of an information processing device according to an embodiment of the present invention.

FIG. 2 is a block diagram showing a specific configuration of the information processing device according to the embodiment of the present invention.

FIG. 3 shows an example of a two-dimensional plane that forms the basis of k-d tree.

(a) of FIG. 4 shows an example of a k-d tree that can be obtained from a two-dimensional space, and (b) of FIG. 4 shows an example of a sequence P of points that can be obtained from the k-d tree.

FIG. 5 is a diagram showing examples of wavelet trees used in the embodiment of the present invention, where (a) and (b) of FIG. 5 show wavelet trees each having a different number of dimensions.

FIG. 6 is a flowchart showing an operation of the information processing device according to the embodiment of the present invention.

FIG. 7 is a flowchart showing an operation of a function “find_intervals(v, Q)” for recursively searching for an interval.

FIG. 8 is a flowchart showing an operation of a function “aggregate_interval(v, s, e, l_{qf}, u_{qf})” for obtaining an aggregation based on a coordinate sequence.

FIG. 9 is a diagram showing changes in the number of search nodes and the inclusive dimension number in a two-dimensional case.

FIG. 10 is a diagram showing a comparison in terms of time complexity between the present invention and a conventional scheme.

FIG. 11 is a block diagram showing an example of a computer that realizes the information processing device according to the embodiment of the present invention.

### DESCRIPTION OF EMBODIMENTS

### Principles of the Invention

First, basic principles of the present invention will be described below, using a typical k-d tree as an example.

First of all, a k-d tree is a binary search tree that is used to handle multidimensional data. A k-d tree is characterized in that the entire space is sequentially divided into two with respect to each dimension from dimension 1 to dimension d. The tree structure of a k-d tree expresses recursive division of a space, and each node of the binary search tree is associated with a partial region. In the present specification, a partial region R(v) associated with a node v is referred to as “the coverage region” of the node. The coverage region R(v) can be expressed as a d-dimensional rectangular range R(v)=[lᵥ₁, uᵥ₁]×[lᵥ₂, uᵥ₂]× . . . ×[l_{vd}, u_{vd}]. In a k-d tree, points that exist in a subtree whose root is node v are included in the coverage region R(v) of v.

Furthermore, each node of a k-d tree can retain a statistical amount regarding a set of points that are included in the subtree whose root is the node. For example, when it is desired to calculate a count query at high speed, for each node, the number of points that are included in the subtree whose root is the node is stored in the node.

An orthogonal range search using a k-d tree is realized in the following manner. First, regarding the root node of the entire tree, which serves as a starting point, it is determined, for each internal node, whether or not the coverage region with which a child node is associated overlaps the query region. Movement to the child node occurs only if the coverage region overlaps the query region, and such an operation is repeatedly performed. Movement to a child node corresponds to dividing the coverage region into two regions with respect to a particular dimension. If the coverage region with which a node is associated is entirely included in the query region, the statistical amount regarding the points included in the subtree, which is stored in the node, is stored as a partial statistical amount. This is because the points included in the subtree are also included in the coverage region, and these points are also included in the query region in this case. This statistical amount is a statistical amount regarding a subset of points that are included in the query region, and therefore the statistical amount is a partial statistical amount.

The node search is complete when the statistical amounts with respect to all of the nodes whose coverage region is completely included in the query region have been found. At this time, an overall statistical amount regarding all of the points included in the query region is calculated and output by aggregating all of these partial statistical amounts.

To provide a more precise description, terms are defined as follows. When a range condition “[lᵥₖ, uᵥₖ]⊂[l_{qk}, U_{qk}]” is satisfied with respect to a dimension k, it is said that “the coverage region R(v) is included in the query region Q with respect to the dimension k”. When the coverage region R(v) satisfies this range condition “[lᵥₖ, uᵥₖ]⊂[l_{qk}, u_{qk}]” with respect to the dimension k, the points included in the coverage region also satisfy the range condition “pₖ⊂[l_{qk}, u_{qk}]” with respect to the dimension k. This is because pₖ⊂[lᵥₖ, uᵥₖ]⊂[l_{qk}, u_{qk}] is true. That is, when a coverage region satisfies the range condition with respect to the dimension k, the points included in the coverage region also satisfy the range condition with respect to the dimension k.

Furthermore, when the coverage region is included in the query region with respect to h dimensions out of d dimensions, it is said that “the inclusion dimension number of the coverage region is h”. If the inclusion dimension number is d, i.e. if the coverage region is included in the query region with respect to all of the dimensions, it is said that the coverage region is completely included in the query region. The inclusive dimension number is a number of conditions that are satisfied out of the d range conditions.

A k-d tree is an approach by which a space is divided until the inclusive dimension number reaches d, i.e., until all of the d range conditions are satisfied.

In a search using a k-d tree, as described above, a search result is obtained by summing the statistical amounts stored in the nodes whose coverage regions are completely included in the given query region. Here, in a k-d tree, some of the coverage regions are included in the query region, but it is necessary to trace all of the nodes that are not completely included in the query region. It is known that the number of such nodes is O(n^{(d-1)/d}). Therefore, the worst time complexity of a k-d tree is O(n^{(d-1)/d}).

In contrast, the present invention is characterized in that a search using a k-d tree is stopped before the coverage regions are completely included in the query region, and switching to a search using a wavelet tree takes place.

More strictly speaking, according to the present invention, the space is divided until the inclusive dimension number reaches d−1, not until the inclusive dimension number reaches d. In this case, a high speed search is realized by using the wavelet tree to find a coordinate that satisfies the range condition with respect to a dimension f (1≦f≦d) that is the last dimension for which the range condition has not been satisfied.

Consequently, according to the present invention, the number of nodes that are to be traced is reduced compared to the conventional approach by which the k-d tree is traced to the last, and it is possible to realize an orthogonal range search that is faster than the case in which the k-d tree is used.

### Concepts Employed in the Present Specification

The following describes various concepts employed in the present specification. In the present specification, coordinates pᵢ of all of the points are expressed by integers [0,n−1]. Also, these integers are expressed by bits having a binary length l=ceil(log n). Note that ceil ( ) denotes a ceiling function. log denotes a binary logarithm function.

For example, when n=8, all coordinates are expressed by integers [0,7], and the binary length l is expressed by l=ceil(log n)=3 (bits). In other words, the binary length l can be expressed by 0=“000”, 1=“001”, 2=“010”, 3=“011”, 4=“100”, 5=“101”, 6=“110”, or 7=“111”.

However, the present invention is also applicable to general multidimensional spaces whose coordinates are not expressed by integers. For example, by employing conversion into a rank space, it is possible to convert n points, where n is a given real number, to integer coordinates within a range [0,n−1], and it is possible to realize an orthogonal range search by using the coordinates. Therefore, by using this conversion into a rank space, it is possible to apply the present invention to general multidimensional spaces that are expressed by real numbers. Note that conversion into a rank space is disclosed in the above-described Non-Patent Document 1, for example.

Also, if values are expressed as binaries composed of “1”s and “0”s, it is possible to employ the present invention even if conversion to a rank space has not been performed. In other words, when the number of data sets is n, the present invention is also applicable to data sets whose coordinates have values that are out of the range [0,n−1]. In the present specification, the range of values of coordinates is limited to the range [0,n−1] in order to logically analyze the time complexity. However, in practice, the present invention can be employed without limiting the range of values of coordinates to the range [0,n−1].

Also, in the present specification, a concept that is called “prefix” is used. A prefix is high-order bits taken out from an integer that is expressed as a binary. In the present specification, the prefix to higher-order h bits of an integer is denoted as a combination of 1, 0, and *, where the number of “1”s and “0”s is h in total, and the number of “*”s is l-h. * is a wild card, and indicates that it may be 1 or 0. If an integer starts with a particular prefix, the integer is included in a particular continuous range.

For example, it can be assumed that an integer is expressed by a bit sequence that has a length of l=3. If this is the case, prefix “0*” having a length of 1 corresponds to four values, namely “000”, “001”, “010”, and “011”. In other words, the prefix corresponds to a range [“000”, “011”]=[0,3], which is the range of integer values. Similarly, prefix “01” having a length of 2 corresponds to two values, namely “010” and “011”, and corresponds to the range of values [“010”, “011”]=[2,3]. A prefix having a length l corresponds to only one integer.

In the present specification, the following denotations are used for a sequence. For example, when there is a sequence A having a length of n, A[0] denotes the first element of A, and A[n−1] denotes the last element of A. Furthermore, a sequence constituted by (e−s+1) elements from the element A[s] of the index s to the element A[e] of the index e on A is represented as A[s,e], and the sequence is represented as A[s,e) if the end A[e] is excluded. Also, elements included in A[s,e] are referred to as elements included in an interval I=[s,e] in A.

Also, in the present specification, the range of coordinate values and the interval between indices of a sequence are strictly distinguished from each other. The range of coordinate values and the interval between the indices of the sequence are both expressed by a pair of numerals. In the present specification, when [l,u] is referred to as “the range”, l and u are coordinate values. On the other hand, when [s,e] is referred to as “the interval”, s and e are indices that relate to a sequence.

### Embodiments

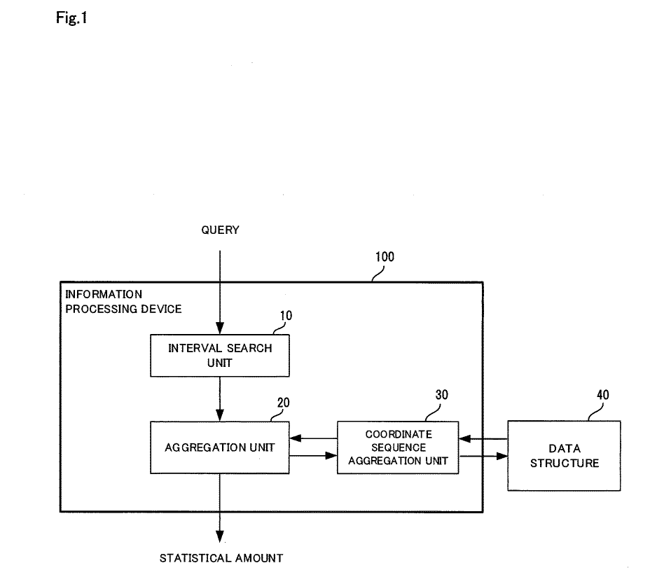

Next, an information processing device, an information processing method, and a program according to embodiments of the present invention will be described with reference to FIGS. 1 to 10.

### Device Configuration

First, an overall configuration of an information processing device according to an embodiment of the present invention will be described with reference to FIG. 1. FIG. 1 is a block diagram showing an overall configuration of the information processing device according to the embodiment of the present invention. An information processing device 100 shown in FIG. 1 according to the present embodiment is a device that processes a data structure 40 that expresses a set of points in a multidimensional space. As shown in FIG. 1, the information processing device 100 includes an interval search unit 10, an aggregation unit 20, and a coordinate sequence aggregation unit 30.

The interval search unit 10 out of these units functions when a particular multidimensional region is specified as the query region. As described above, the query region is expressed by a combination of d ranges respectively corresponding to dimensions, for example.

The interval search unit 10 specifies an interval that is constituted only by points that are included in a sequence P that is obtained by arranging a set of points in a sequence, and whose coordinates with respect to each of the dimensions that constitute a multidimensional space except for one dimension are included in the query region. In other words, the interval search unit 10 specifies zero or more intervals of indices of the sequence P that include points that satisfy d−1 conditions out of d conditions that are to be satisfied by points that are included in the query region. The interval search unit 10 outputs the specified intervals to the aggregation unit 20.

Regarding the intervals specified by the interval search unit 10, the aggregation unit 20 specifies the range of coordinate values with respect to the one excluded dimension, as the condition that is to be satisfied by points that are included in the query region, and outputs the range of the specified coordinate values and the interval specified by the interval search unit 10 to the coordinate sequence aggregation unit 30.

In other words, the aggregation unit 20 specifies, with respect to the dimension f that corresponds to the last range condition that has not been satisfied by the points included in each interval of the sequence P of the points specified by the interval search unit 10, the range of coordinate values that serve as range conditions that are to be satisfied by the points included in the query region. Then, the aggregation unit 20 sends an inquiry to the coordinate sequence aggregation unit 30 corresponding to the dimension f, by providing the coordinate sequence aggregation unit 30 with the interval between the indices of the sequence P specified by the interval search unit 10, and the range of coordinate values that serves as the range condition for coordinate values with respect to the dimension f.

The coordinate sequence aggregation unit 30 functions upon being provided with the interval (the interval between indices) specified by the interval search unit 10 and the range of coordinate values with respect to the dimension f. Upon receiving the inputs, the coordinate sequence aggregation unit 30 calculates the statistical amount regarding the points corresponding to all of the coordinates that appear in the input interval and whose value are included in the input range, with respect to the coordinate sequence obtained by taking out the coordinates of the set of points with respect to the dimension f, in the same order as the order in which the sequence P of the points is arranged. Also, the coordinate sequence aggregation unit 30 outputs the statistical amount thus calculated to the aggregation unit 20.

In this way, with the information processing device 10, a multidimensional space is divided until d−1 conditions out of the d conditions that express the query region are satisfied, and therefore the time complexity required for dividing the query region is reduced compared to the case of searching the k-d tree. Therefore, according to the information processing device 10, it is possible to realize orthogonal range search with respect to a desired dimension d at a higher speed compared to cases of k-d trees, by using a data structure having a linear size.

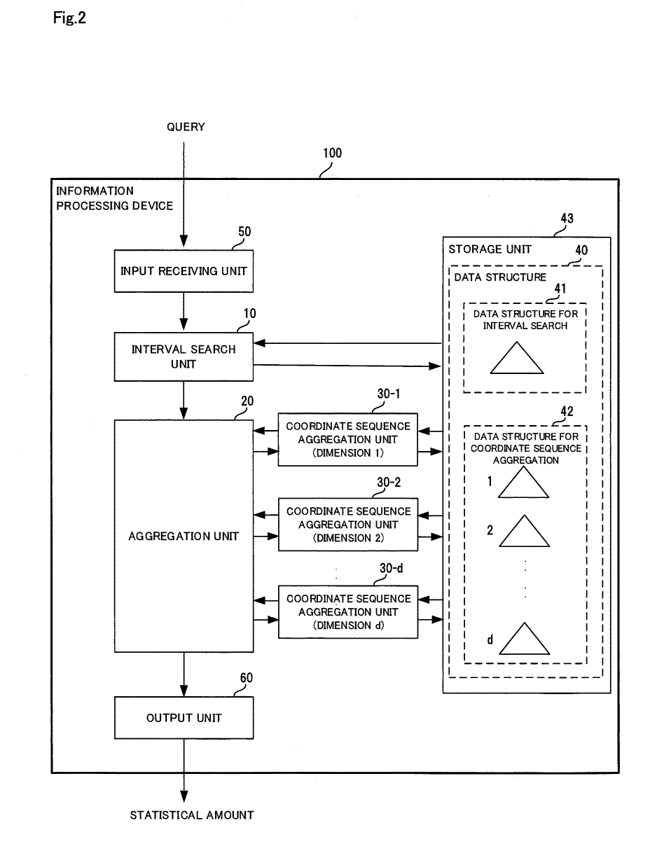

Next, the configuration of the information processing device 100 according to the present embodiment will be more specifically described with reference to FIG. 2. FIG. 2 is a block diagram showing a specific configuration of the information processing device according to the embodiment of the present invention.

As shown in FIG. 2, the information processing device 100 according to the present embodiment includes, in addition to the interval search unit 10, the aggregation unit 20, and the coordinate sequence aggregation unit 30 described above, a storage unit 43, an input receiving unit 50, and an output unit 60.

Also, in the present embodiment, d coordinate sequence aggregation units 30-1 to 30-d are provided for the respective dimensions. Each of the coordinate sequence aggregation units 30-1 to 30-d calculates the statistical amount regarding a set of points when the corresponding dimension coincides with the dimension of the interval specified by the interval search unit 10. Note that, in the following description, the coordinate sequence aggregation units are denoted as “the coordinate sequence aggregation units 30” when they are not distinguished from each other.

The input receiving unit 50 receives an input of a query region from the outside, and outputs the query region to the interval search unit 10. The storage unit 43 stores the data structure 40. In the present embodiment, the data structure 40 includes a data structure 41 for interval search, which is used by the interval search unit 10 to specify an interval, and a data structure 42 for coordinate sequence aggregation, which is used by the coordinate sequence aggregation unit 30 to calculate a statistical amount.

Upon receiving a query region output from the input receiving unit 50, the interval search unit 10 sends an inquiry to the storage unit 43 and acquires the data structure 41 for interval search. The data structure 41 for interval search is a data structure used by the interval search unit 10 upon a query region being specified, to specify, from the sequence P of points, an interval that includes points that satisfy d−1 conditions out of d conditions that express the query region.

In the present embodiment, a data structure that is expressed as a tree structure having nodes can be used as the data structure 41 for interval search. In this data structure, nodes are associated with any of a plurality of coverage regions that are set to the multidimensional space, as well as with an interval in which the points included in the corresponding coverage region appear in the sequence of points. Specifically, a k-d tree can be used as the data structure 41 for interval search. In the present embodiment, the data structure 41 for interval search is not limited to a k-d tree, and may be any data structure in which nodes of the tree configuration are associated with a rectangular region. Other examples are data structures referred to as a k-d-B tree, an R tree, and a bounding volume hierarchy (BVH).

In the present embodiment, the interval search unit 10 specifies, out of nodes, a node for which coordinates of points that exist in the associated coverage region, with respect to the dimensions except for one dimension, are included in the query region. The interval search unit 10 specifies an interval with which one or more specified nodes are associated.

The following will describe further details of the data structure 41 for interval search. As described above, in the present embodiment, a k-d tree can be used as the data structure 41 for interval search. A k-d tree is a binary tree in which each node is associated with a rectangular region that is set in a multidimensional space. This rectangular region is the above-described coverage region. The coverage region of the root node of a k-d tree is the entire region on the grid, namely [0,n−1]×[0,n−1]×[0,n−1]× . . . , ×[0,n−1]. The depth of the nodes is reduced by one when the space is divided into two with respect to one of the dimensions, and the dimension with respect to which division is to be performed is repeatedly selected in the order of 1, 2, 3, . . . , d.

A k-d tree can be recursively built from the root node that serves as a starting point, in the following manner. First, for each internal node, when the dimension used for division at the depth is k, the coordinates of all of the points included in the coverage region of the internal node with respect to the dimension k are found out, and the coordinate having the median value is selected, and the coverage region is divided into two by using this coordinate. That is, when the coordinate is denoted by t, the coverage region can be divided into a region in which the coordinate with respect to the dimension k is smaller than t, and a region in which the coordinate with respect to the dimension k is larger than or equal to t.

The two child nodes of this internal node correspond to the two regions that have been acquired by division. The k-d tree is built by recursively performing such division on the left child node and the right child node. Each internal node retains coordinates that have been used for division. Therefore, such division is repeatedly performed until only one point is included in the coverage region, and then the leaf nodes associated with the coverage region are built and retained. The terminal leaf node retains the point per se included in the coverage region. In the case where each point is assigned a weight, the leaf node also retains such a weight.

Here, regarding the coverage region R(v) of each node v of the k-d tree, the node v may directly retain the value of the coverage region, or dynamically calculate the value of the coverage region when searching the k-d tree, from the coordinates that are retained by the traced nodes and have been used for division.

Note that, although there are a plurality of variations of the method for defining a k-d tree, any definition may be used in the present embodiment. Also, although the description of the present embodiment is provided by using a definition in which only the coordinate that has been used by the internal node of the k-d tree to perform division is retained, the present invention is not limited in such a manner. In the present embodiment, a definition in which the point per se that has been used by the internal node of the k-d tree to perform division is retained may be used. Also, as described below, it is not essential that a definition in which a leaf node retains one point is used, and a definition in which a leaf node retains a plurality of points may be used.

In the above-described sequence P of points, the points are obtained by arranging points included in the set of points in a sequence such that the points that exist in the coverage regions respectively associated with the nodes appear in series.

Specifically, the sequence P of points is defined as follows by using the k-d tree that has been built. First, it is assumed that the sequence P of points arranged based on the order in which the points will be found when an in-order search is performed on the k-d tree. In other words, a search starts from the root node of the k-d tree, and first, the left subtree is searched, the root node itself is traced, and then the right subtree is searched. If such a search order is recursively applied to all of the nodes, all of the points included in the k-d tree are accessed once. The sequence obtained by arranging the points in this way is denoted as P.

In this case, regarding a given node v of the k-d tree, an interval Iᵥ=[s, e] that satisfies the following condition exists. The condition is that a set of points included in the interval L in the sequence P of points coincides with a set of points that are included in the subtree whose root node is v. It is assumed that each node v retains such an interval L. In this case, the number nᵥ of points included in the subtree of v can be calculated by a formula nᵥ=e−s+1.

Furthermore, k coordinate sequences Pₖ that correspond to the sequence P of points are considered. Note that Pₖ are coordinate sequences that can be obtained by taking out a coordinate of each point with respect to the dimension k in the same order as the sequence P of points.

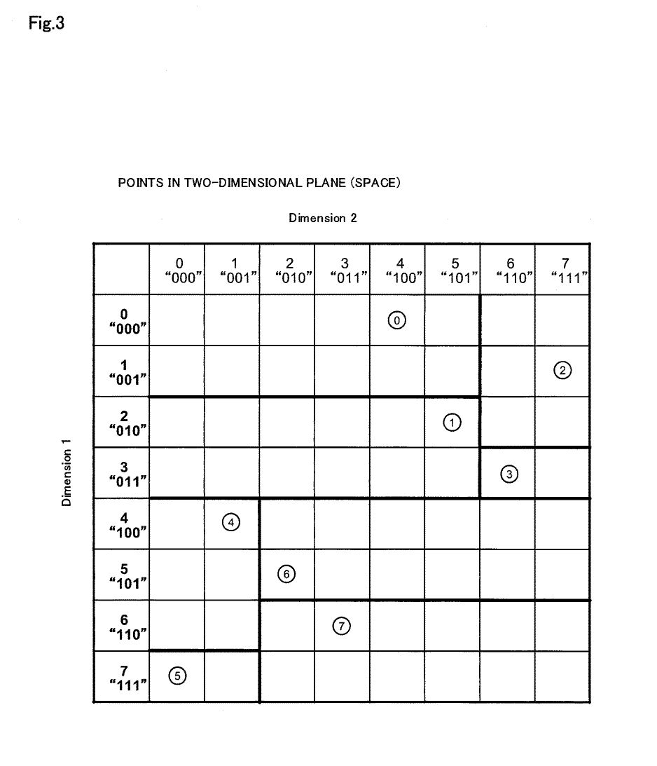

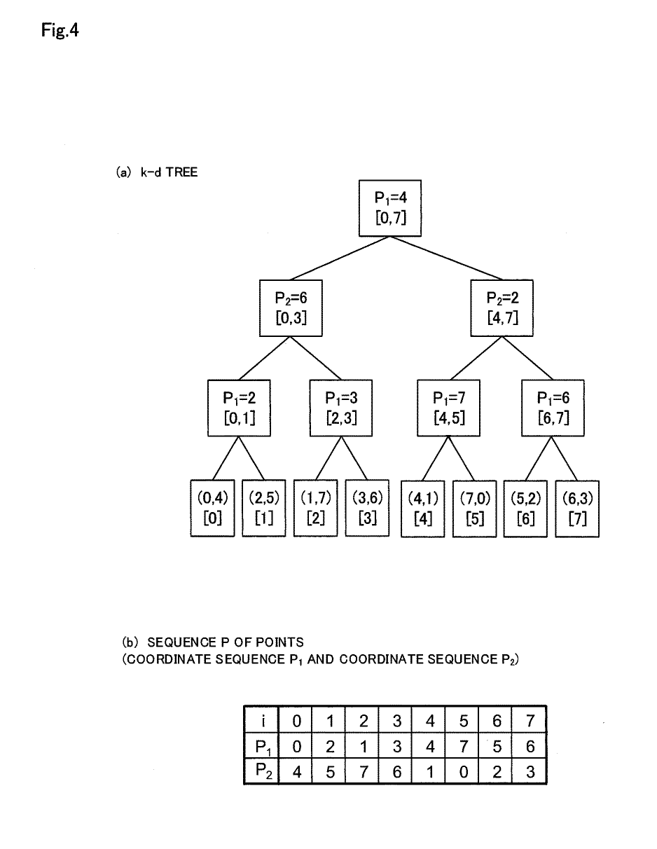

Here, a specific example of the k-d tree is described with reference to FIGS. 3 and 4. In the following description, it is assumed that the number d of dimensions is two. FIG. 3 shows an example of a two-dimensional plane that forms the basis of a k-d tree. (a) of FIG. 4 shows an example of the k-d tree that can be obtained from a two-dimensional space, and (b) of FIG. 4 shows an example of the sequence P of points that can be obtained from the k-d tree.

As shown in FIG. 3, a plurality of points exist on a two-dimensional plane. Specifically, there are n=8 points on the two-dimensional plane that is expressed as a [0,7]×[0,7] grid. Each point is given one of the numbers 0 to 7, and these numbers indicate the order in the sequence P of points as described below. That is, the point with “0” indicates a point P[0], which is the first point in the sequence P of points. The bold lines on the grid indicate division of a space caused by the nodes of the k-d tree. The horizontal bold lines indicate division with respect to the dimension 1, and the vertical bold lines indicate division with respect to the dimension 2.

Also, as shown in (a) of FIG. 4, each of the points shown in FIG. 3 is stored in the k-d tree. In this tree structure, the nodes with a depth of an even number indicate division with respect to the dimension 1, and the nodes with a depth of an odd number indicate division with respect to the dimension 2. The equations shown above the internal nodes indicate which coordinate is used to divide the space. Furthermore, for each node, an interval Iᵥ corresponding to the node in the sequence P of points is shown below the node. In the leaf nodes, a point represented by a pair of coordinate is retained instead of a coordinate that is used for division.

Also, as shown in (b) of FIG. 4, the sequence P of points corresponds to the points shown in FIG. 3 and the k-d tree shown in (a) of FIG. 4. According to the definition, coordinate sequences P₁ and P₂ are expressed by the same drawings. In (b) of FIG. 4, the first row shows the value of an index i, the second row shows the coordinate sequence P₁, and the third row shows the coordinate sequence P₂. As shown in this drawing, P[0]=(P₁[0],P₂[0])=(0,4), for example.

Next, a description will be given of the fact that the example of a k-d tree shown in (a) of FIG. 4 satisfies the above-described definition of the k-d tree. For example, the root node v of the k-d tree has the entire region of the given grid, as the coverage region R(v). That is, the coverage region R(v)=[0,7]×[0,7]. Furthermore, since all of the points are included as child nodes of the root node, the interval Iᵥ=[s, e]=[0,7] is satisfied. The root node has a depth of 0, and divides the space with respect to the dimension 1. Attention is paid to the coordinate having the median value p₁=4 with respect to the dimension 1, and the space is divided into a region that satisfies p₁<4 and a region that satisfies 4≦p₁. Therefore, the coverage region of the left child node is [0,3]×[0,7], and the coverage region of the right child node is [4,7]×[0,7]. The space is built by being divided in the same manner thereafter.

Also, since the sequence P of points is arranged according to the order in which an in-order tracing was performed on the k-d tree, all of the points included in the interval Iᵥ in the sequence P of points, with respect to all of the nodes, are included in the subtree whose root is the corresponding node. For example, in (a) of FIG. 4, the left child node of the root node of the entire tree is Iᵥ=[0,3], which means that four points P[0] to P[3] are included in the subtree whose root is this node.

In the present embodiment, the coordinate sequence aggregation unit 30 first specifies, from among a plurality of subsequences that can be obtained from the coordinate sequence, a subsequence in which only coordinates that are included in the input range appear, by using the data structure 42 for coordinate sequence aggregation. Then, the coordinate sequence aggregation unit 30 specifies an interval that is an interval in the specified subsequence and in which coordinates that appear in the input interval in the coordinate sequence appear, and calculates the statistical amount regarding the set of points corresponding to the coordinates that appear in the interval in the specified subsequence. Note that, as described below, an example of a subsequence is a subsequence that can be obtained by extracting coordinates whose bit representations start with the same prefix, while maintaining the positional relationship between the coordinates.

Also, in the present embodiment, the data structure 42 for coordinate sequence aggregation is a data structure that expresses a coordinate sequence Pₖ that corresponds to each of the dimensions k, namely the dimensions 1 to d. Note that Pₖ is a coordinate sequence that can be obtained by taking out a coordinate of each point with respect to the dimension k in the same order as the sequence P of points. The data structure 42 for coordinate sequence aggregation is a data structure that, when an interval between indices on the coordinate sequence Pₖ and a range of coordinate values are input to the coordinate sequence aggregation unit 30, makes it possible to calculate, with respect to all of the coordinates whose positions in the coordinate sequence are included in the input interval and whose values are included in the input range, the statistical amount regarding the set of points that corresponds to the coordinates.

An example of the data structure 42 for coordinate sequence aggregation is a data structure that has a plurality of nodes that are associated with the above-described subsequence. If this is the case, each node can be expressed by using a bit sequence that can be obtained by taking out, from bit representations of the coordinates that appear in the subsequence, one or more bits in a particular digit, and arranging the bits thus taken out in the same order as the subsequence. In this case, the coordinate sequence aggregation unit 30 specifies an interval in the subsequence by using bit sequences that express the nodes.

Specifically, in the present embodiment, a wavelet tree can be used as the data structure 42 for coordinate sequence aggregation. If this is the case, the interval search data structure 42 is built by using d wavelet trees that respectively correspond to the dimensions 1 to d. The set of these d wavelet trees is denoted as W={wₖ}.

However, note that, in the present embodiment, the data structure 42 for coordinate sequence aggregation is not limited to wavelet trees. The data structure 42 for coordinate sequence aggregation is only required to be a data structure from which, when an interval between indices on an integer sequence and the range of the values of integers are given as conditions, points that are in the integer sequence, are included in the interval, and satisfy the range conditions can be searched for. Other examples of the data structure 42 for coordinate sequence aggregation include Chazelle's compressed range tree, Compressed Range B-tree (CRB-tree) that is an expanded compressed range tree using an external storage, and so on.

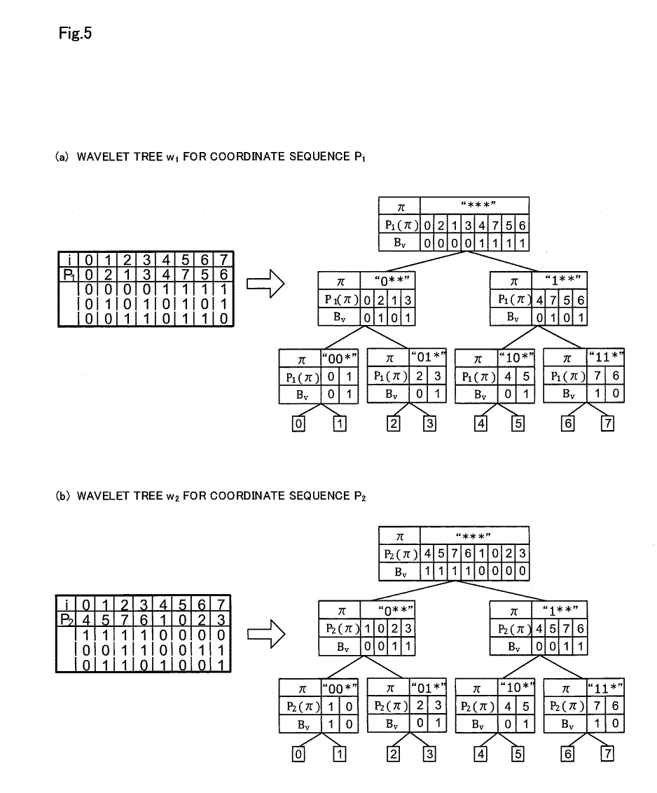

Here, specific examples of the data structure 42 for coordinate sequence aggregation, namely, specific examples of d wavelet trees, will be described with reference to FIG. 5 in addition to the above-described FIGS. 3 and 4. In the following description, it is assumed that the number of dimensions is two. FIG. 5 is a diagram showing examples of wavelet trees used in the embodiment of the present invention, where (a) and (b) of FIG. 5 show wavelet trees each having a different number of dimensions.

(a) of FIG. 5 shows a coordinate sequence P₁ and a wavelet tree w₁ that corresponds to the coordinate sequence P₁, and (b) of FIG. 5 shows a coordinate sequence P₂ and a wavelet tree w₂ that corresponds to the coordinate sequence P₂. The tables shown on the left side of the drawings express coordinate sequences. The first row shows an index i of the sequence, and the second row shows integers corresponding to the indices. The third row and the subsequent rows show bit representations of the integers.

The wavelet tree corresponding to the coordinate sequence Pₖ with respect to the dimension k is defined as a binary tree as follows. Note that a wavelet tree is a binary tree having a depth of 1. In this tree structure, the edge from the parent to the child on the left side corresponds to the bit 0, and the edge from the parent to the child on the right side corresponds to the bit 1.

First, it is assumed that the root node of a wavelet tree is located at a depth of 0, and corresponds to a coordinate prefix having a length of 0 bits. It is also assumed that a node v located at a depth of h in the wavelet tree corresponds to an h-bit coordinate prefix n that can be obtained by concatenating h bits that appear in the path from the root node to the node. Nodes located at a depth of 1 are all leaf nodes. A leaf node corresponds to one integer that is expressed by 1 bits that can be obtained by concatenating 1 bits that appear in the path from the root to the node.

Furthermore, the node v that is located at a depth of h in the wavelet tree and corresponds to the coordinate prefix π corresponds to a subsequence Pₖ(π) in the coordinate sequence Pₖ. Note that Pₖ(π) is a subsequence that is taken out of the coordinate sequence Pₖ such that all of the integers that start with the coordinate prefix n are maintained in the same order as the original order. In the present specification, the original Pₖ and the subsequence Pₖ(π) that is taken out, with attention being paid to the coordinate prefix n, are separately referred to as “the coordinate sequence” and “the coordinate subsequence”, respectively.

When Pₖ(π)[i], which is an element of the index i of the coordinate subsequence Pₖ(π) corresponds to Pₖ[j], which is an element of the index j of the original coordinate sequence Pₖ, Pₖ(π)[i] originally is a coordinate of the point P[j] with respect to the dimension k. If this is the case, it is said in the present specification that the coordinate Pₖ(π)[i] belongs to the point P[j].

It is also assumed that the node v stores a bit sequence Bᵥ that is obtained by taking out only the (h+1)^{th} bits of the elements of Pₖ(π) and concatenating the bits in the same order. In other words, the bit sequence Bᵥ satisfies Bᵥ[i]=0 if the (h+1)^{th} bit of an integer Pₖ(π)[i] is 0, and satisfies Bᵥ[i]=1 if the (h+1)^{th} bit is 1.

Specifically, as shown in (a) and (b) of FIG. 5, in the present embodiment, a wavelet tree w₁ that is built for a coordinate sequence P₁ with respect to the dimension 1 and a wavelet tree w₂ that is built for a coordinate sequence P₂ with respect to the dimension 2 are used. Also, (a) and (b) of FIG. 5 show, for each node, the coordinate prefix n, the coordinate subsequence Pₖ(π), and the bit sequence Bᵥ corresponding to the node.

Also, as shown in (a) and (b) of FIG. 5, the wavelet tree w₁ is a wavelet tree for the coordinate sequence P₁=(0,2,1,3,4,7,5,6). Each element of the coordinate sequence P₁ is expressed as three bits. The root node of each wavelet tree is linked with the coordinate prefix π=“***”. Therefore, this coordinate prefix corresponds to all of the values that can be expressed by three bits, i.e. all the values that fall within the range of [“000,” 111”]=[0,7]. For this reason, the root node stores 0+1=1^{st} bits of the coordinate subsequence Pᵢ(π) as the bit sequence Bᵥ.

Next, the child node on the left side of the root node corresponds to the prefix “0**”, and corresponds to integers composed of three bits whose first bit is 0, i.e. corresponds to the range [0,3], and also corresponds to the coordinate subsequence P₁(π)=(0,2,1,3), which is obtained by taking out only the values that fall within the range [0,3] from the coordinate sequence P₁. Therefore, this left child node stores the second bit as the bit sequence By. Note that the same applies to the subsequent child nodes.

The wavelet tree retains a succinct dictionary of the bit sequence By with respect to each inner node v. The succinct dictionary is a data structure that supports three kinds of operations, namely access, rank, and select, that are to be performed on a bit sequence B having a length of n. These three kinds of operations can be defined as follows:

access(B,i) returns element B[i] of index i on B;

rank1(B,i) returns the number of 1s that exist in the range of B[0,i);

rank0(B,i) returns the number of 0s that exist in the range of B[0,i);

select1(B,i) returns position j at which the (i+1)^{th} 1 appears on B; and

select0(B,i) returns position j at which the (i+1)^{th} 0 appears on B.

Note that the succinct dictionary may also be referred to as a succinct bit vector or a rank/select dictionary, depending on documents.

In the examples shown in (a) and (b) of FIG. 5, for the sake of explanation, with respect to each node in the wavelet tree, the coordinate prefix n, the coordinate subsequence Pₖ(π), and the bit sequence Bᵥ are shown. However, in reality, the wavelet tree retains only the succinct dictionary for Bᵥ, and does not need to retain the coordinate prefix n and the coordinate subsequence Pₖ(π). This is because it is possible to calculate the coordinate prefix n from information regarding edges that have been followed, and it is possible to calculate each element of the coordinate subsequence Pₖ(π) by using the succinct dictionary for the bit sequence By. Therefore, in reality, only the succinct dictionary is retained in the storage unit 43 as the data structure 42 for coordinate sequence aggregation.

Note that the wavelet tree is defined in various manners in different documents. In the above-described Non-Patent Document 1, the wavelet tree is defined without using a prefix. However, in the present specification, the wavelet tree is defined by using a prefix for the sake of explanation. The essential structure of the wavelet tree is the same for both definitions, and the same operations can be realized.

Also, the wavelet tree only needs to have a structure that allows for a search through a tree structure, i.e. a structure having a plurality of nodes, and does not need to be explicitly configured as a tree structure. For example, there is a known method called a wavelet matrix, by which a wavelet tree is implemented without classifying bit sequences for each node. The discussion carried out regarding the present invention applies to cases in which the wavelet matrix is employed, in exactly the same manner.

If a plurality of intervals are specified by the interval search unit 10, the aggregation unit 20 further aggregates the statistical amounts (i.e. partial statistical amounts) of the intervals, calculated by the coordinate sequence aggregation unit 30. In this case, the aggregation unit 20 outputs the overall statistical amount thus obtained by aggregation to the output unit 60 as the overall statistical amount regarding the set of points included in the query region. Thereafter, the output unit 60 outputs the overall statistical amount that has been output by the aggregation unit 20, to an external terminal device, a server device, and so on.

### Outline of Search Algorithm

Next, before the operation of the information processing device 100 is described, the outline of the search algorithm used by the information processing device 100 will be described below.

First, a node whose coverage region overlaps the query region and whose coverage region has an inclusive dimension number of d−1 is found by using a k-d tree. This means that d−1 range conditions out of the d range conditions that are to be satisfied when the coverage region of the node is included in the query region are satisfied. Here, the dimension with respect to which the condition is not satisfied is denoted as f.

If attention is paid to the interval Iᵥ=[s,e] of the index retained by the node v, points that are included in the P[s,e] out of the sequence P of points are points that are included in the subtree whose root is the node v. Therefore, it is guaranteed that the query range conditions are satisfied with respect to the dimensions other than the dimension f. However, it is not guaranteed that the range condition with respect to the dimension f is satisfied.

Therefore, attention is paid to a coordinate sequence P_{f} with respect to the dimension f. If a coordinate P_{f}[i] included in P_{f}[s,e] satisfies the range condition with respect to the dimension f, the point P[i] corresponding to the coordinate P_{f}[i] satisfies d range conditions with respect to all of the dimensions. More strictly speaking, when i satisfies s≦i≦e, if a coordinate P_{f}[i] further satisfies the range condition l_{qf}≦P_{f}[i]≦u_{qf} with respect to the dimension f, the coordinate P_{f}[i] belongs to the point P[i] that satisfies all of the query range conditions.

Such characteristics are used in the present embodiment. That is, with respect to all of the coordinates that are included in P_{f}[s,e] and whose coordinate values are included in the query range [l_{qf},u_{qf}] with respect to the dimension f, the statistical amount of the set of points to which the coordinates belong is calculated. This statistical amount can be calculated at high speed by using a wavelet tree. This statistical amount is equal to the statistical amount of the set of points that are included in P[s,e] and that are included in the query. It is possible to calculate the overall statistical amount regarding the entire set of points included in the query by calculating the statistical amount for all of the intervals.

### Device Operation

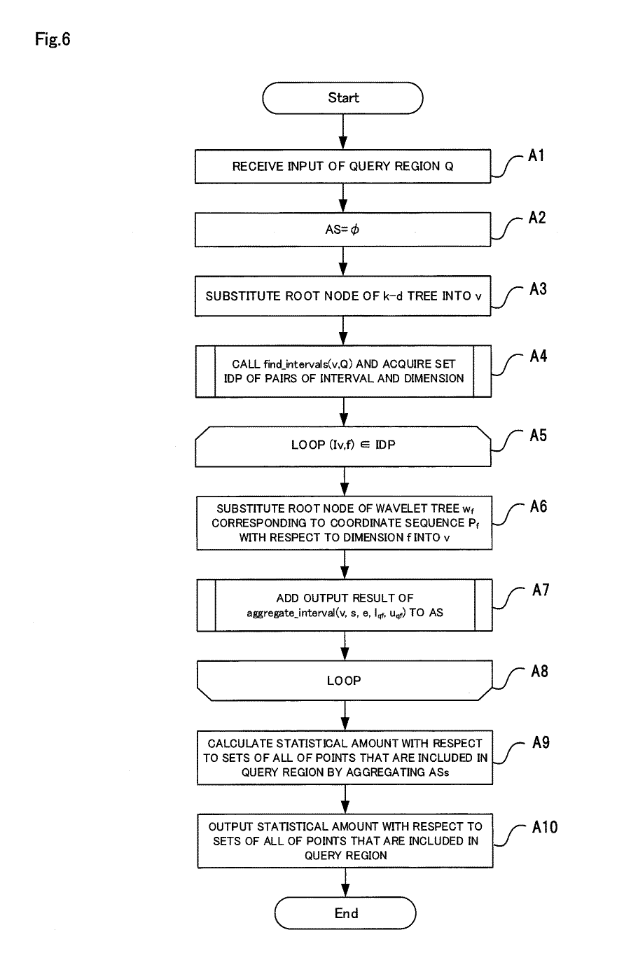

Next, the operation of the information processing device 100 according to the embodiment of the present invention will be described with reference to FIG. 6. FIG. 6 is a flowchart showing the operation of the information processing device according to the embodiment of the present invention. In the following description, FIGS. 1 to 5 are referred to where appropriate. In the present embodiment, information processing method is performed by operating the information processing device 100. Therefore, a description of the information processing method according to the present embodiment may be replaced by the following description of the operation of the information processing device 100.

As shown in FIG. 6, first, the input receiving unit 50 externally receives an input for specifying the range of the query region (step A1), and outputs the received content to the interval search unit 10. This input query region Q is denoted as Q=[l_{q1}, u_{q1}]×[l_{q2}, u_{q2}]× . . . ×[l_{qd}, u_{qd}].

Next, the interval search unit 10 sets an empty set to a variable AS that expresses a set of statistical amounts (step A2). This variable AS is a variable for storing partial statistical amounts regarding a subset of points included in the query, as preliminary aggregation results.

Next, the interval search unit 10 sends an inquiry to the storage unit 43, and acquires the data structure 41 for interval search, which is a k-d tree. The interval search unit 10 substitutes the root node of the k-d tree into a variable v (step A3). This variable v is a variable that expresses the node to which attention is currently paid.

The interval search unit 10 applies a function “find_intervals(v,Q)” to the data structure 41 for interval search with respect to the query region Q, and acquires a set IDP of pairs of an interval and a dimension as a return value (step A4). The pair of the interval Iᵥ[s,e] and the dimension f included in the IDP express that e−s+1 points included in P[s,e] in the sequence P of points satisfy d−1 range conditions with respect to the dimensions other than the dimension f. The function “find_intervals(v,Q)” is a function that returns such an IDP.

If points that are included in the query and are not included in the intervals in the sequence P of points are found, the function “find_intervals(v,Q)” separately calculates the statistical amounts of these points, and stores the statistical amounts in the variable AS. The interval search unit 10 outputs IDP and AS to the aggregation unit 20.

Next, the aggregation unit 20 receives IDP and AS from the interval search unit 10, and starts a loop with respect to the pairs of the interval Iᵥ[s,e] and the dimension f included in IDP (step A5). That is, the aggregation unit 20 executes steps A6 and A7 with respect to all of the pairs included in IDP.

Next, the aggregation unit 20 outputs the interval Iᵥ to the coordinate sequence aggregation unit 30-f for the dimension f. The coordinate sequence aggregation unit 30-f for the dimension f receives the interval Iᵥ as an input, sends an inquiry to the storage unit 43, and acquires the data structure 42 for coordinate sequence aggregation corresponding to the coordinate sequence P_{f} with respect to the dimension f, namely, a wavelet tree w_{f}. Then, the coordinate sequence aggregation unit 30-f for the dimension f substitutes the root node of the wavelet tree w_{f} into the variable v (step A6).

The coordinate sequence aggregation unit 30-f for the dimension f calls a function “aggregate_interval(v, s, e, l_{qf}, u_{qf})”, and adds the statistical amount (the output result) returned by this function, to AS (step A7). This function “aggregate_interval(v, s, e, l_{qf}, u_{qf})” is executed with reference to the wavelet tree w_{f}. The function “aggregate_interval(v, s, e, l_{qf}, u_{qf})” is a function that specifies, with respect to the set of all of the coordinates P_{f}[i] that satisfy l_{qf}≦P_{f}[i]≦u_{qf} out of the coordinates included in P_{f}[s, e] with respect to the coordinate sequence P_{f}, a set of all of the points to which the coordinates included in the set belong, and returns a statistical amount regarding the set of points. These points are some of the points included in the query, and the statistical amount is a partial statistical amount.

For example, COUNT, which indicates the number of points that satisfy the condition, and SUM, which indicates the sum of the weights of the points that satisfy the condition, may be used as the statistical amount.

The aggregation unit 20 ends the loop after step A7 has been executed with respect to all of the pairs included in IDP (step A8).

The aggregation unit 20 calculates the overall statistical amount with respect to the sets of all of the points included in the query region by using the partial statistical amounts included in ASs (step A9). For example, if COUNT is used as the statistical amount, the aggregation unit 20 can obtain COUNT of the set of all of the points included in the query region by summing the counts included in AS.

Finally, the output unit 60 outputs the overall statistical amount received from the aggregation unit 20, with respect to the set of all of the points included in the query region, to the outside (step A10). The search processing with respect to the query region Q is complete upon the execution of steps A1 to A10. Steps A1 to A10 are executed every time the query region Q is input.

### Step A4

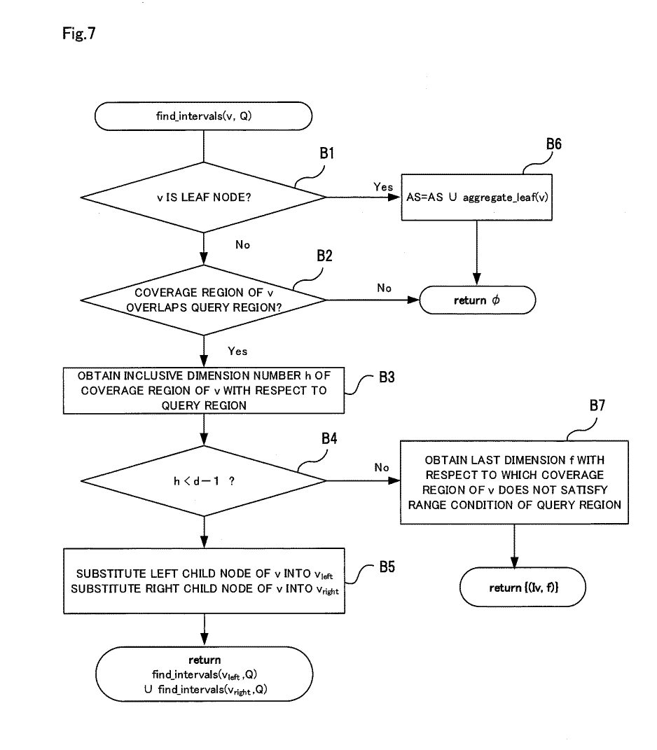

Next, step A4 shown in FIG. 6 will be more specifically described with reference to FIG. 7. FIG. 7 is a flowchart showing the operation of the function “find_intervals(v, Q)” for recursively searching for an interval. This function is realized by the interval search unit 10 sending an inquiry to the storage unit 43.

As shown in FIG. 7, first, the interval search unit 10 determines whether or not node v of the k-d tree is a leaf node (step B1). If the result of determination in step B1 is “Yes”, the interval search unit 10 finds out, with respect to all of the points retained by the leaf node, whether or not the points are included in the query region, calculates the statistical amount with respect to the points that are retained by the leaf node and are included in the query region, and adds the statistical amount to AS (step B6). In step B6, if necessary, the interval search unit 10 performs the calculation with reference to weights retained by the leaf node (step B6).

Also, as shown in FIG. 7, the operation performed in step B6 is expressed by an expression AS=AS∪aggregate_leaf(v). aggregate_leaf(v) is a function for finding out whether or not all of the points retained by a leaf node are included in the query region, and calculating and returning the statistical amounts regarding the points included in the query region. For example, when the count query is to be realized, the function “aggregate_leaf(v)” counts and returns the number of points included in the query region out of all of the points retained by the leaf node v. When the above-described processing regarding the leaf node has been performed, the interval search unit 10 returns an empty set.

On the other hand, if the result of determination in step B1 is “No”, the interval search unit 10 determines whether or not the coverage region of the node v of the k-d tree overlaps the query region (step B2). If the result of determination performed in step B2 is “Yes”, the interval search unit 10 proceeds to step B3, and if the result is “No”, the interval search unit 10 returns an empty set.

Specifically, in step B2, the interval search unit 10 obtains the coverage region R(v)=[lᵥ₁,uᵥ₁]×[lᵥ₂,uᵥ₂]× . . . ×[l_{vd},u_{vd}] of the node v of the k-d tree. Then, the interval search unit 10 determines whether or not “uᵥₖ<l_{qk} or u_{qk}<lᵥₖ” is satisfied with respect to at least one of the dimensions k when k satisfies 1<k<d. As a result of the determination, if the above-described relationship is true, the interval search unit 10 determines that the result is “No” because there is no spatial overlap. If the above-described relationship is not true, the interval search unit 10 determines that the result is “Yes” because there is a spatial overlap. The determination in step B2 is performed in order to perform pruning so that a coverage region that does not overlap the query region is prevented from being further searched.

Next, the interval search unit 10 compares the coverage region of the node v with the query region to calculate an inclusive dimension number h (step B3). Specifically, the interval search unit 10 can calculate the inclusive dimension number h by counting the number of dimensions k that satisfy l_{qk}≦lᵥₖ, and uᵥₖ≦u_{qk} according to the definition, for example.

Next, the interval search unit 10 determines whether or not the inclusive dimension number h is smaller than d−1 (step B4). If the result of determination in step B4 is “Yes”, the interval search unit 10 substitutes the left child node of the node v into the variable v_{left}, and substitutes the right child node of the node v into the variable v_{right} (step B5).

After performing step B5, the interval search unit 10 recursively calls the same function in the following manner. return find_intervals(v_{left}, Q)∪find_intervals(v_{right}, Q)

If the result of determination in step B4 is “No”, the interval search unit 10 compares the coverage region of the node v with the query region, and obtains a dimension f that does not satisfy the range condition “l_{qf}≦l_{vf} and u_{vf}≦u_{qf}” (step B7). Then, the interval search unit 10 returns (Iᵥ,f), which is a pair of the interval Iᵥ of the indices retained by the node v, and the dimension f.

This concludes the description of the operation according to the algorithm shown in FIG. 7. Although the algorithm shown in FIG. 7 is almost the same as the conventional k-d tree search algorithm, it is different from the conventional k-d tree search in that the search is performed until nodes that satisfy d−1 range conditions have been found, instead of being performed until nodes that satisfy all of the d range conditions have been found.

### Step A7

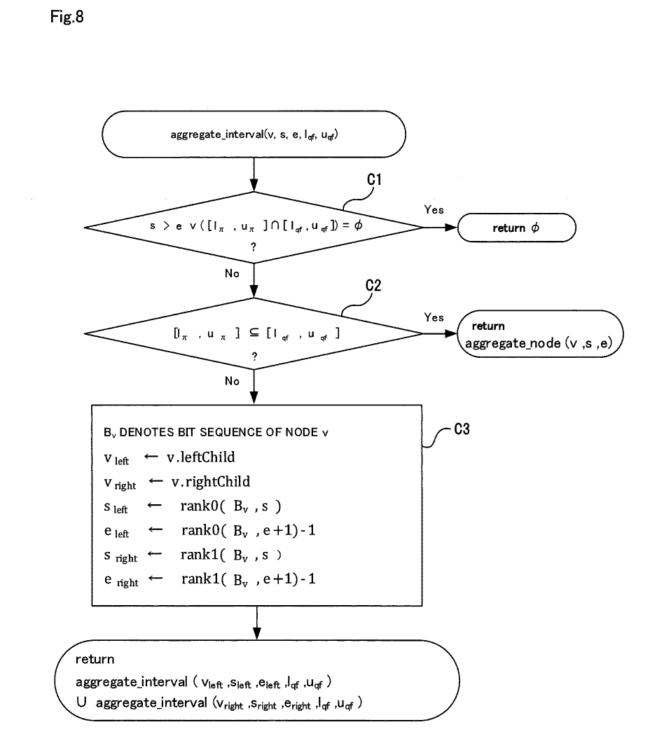

Next, the operation performed in step A7 according to the algorithm shown in FIG. 6 will be described in detail with reference to FIG. 8. Specifically, the operation of the function “aggregate_interval(v, s, e, l_{qf}, u_{qf})” shown in FIG. 6 will be described with reference to FIG. 8. FIG. 8 is a diagram that shows the operation of the function “aggregate_interval(v, s, e, l_{qf}, u_{qf})” shown in step A7 in FIG. 6.

The function “aggregate_interval(v, s, e, l_{qf}, u_{qf})” is a function that is executed by the coordinate sequence aggregation unit 30-f for the dimension f. This function receives the node v of the wavelet tree w_{f}, the interval [s, e] between indices, and the range [l_{qf}, u_{qf}] of coordinate value as inputs, and returns, with respect to all of the coordinates whose values are included in the range out of the coordinates included in the interval in the coordinate subsequence P_{f}(π) corresponding to v, the statistical amounts regarding the points to which the coordinates belong.

As shown in FIG. 8, the coordinate sequence aggregation unit 30-f for the dimension f executes the function “aggregate_interval(v, s, e, l_{qf}, u_{qf})”, and determines whether or not s>e or ([l_{π}, u_{π}]∩[l_{qf}, u_{qf}])=φ is satisfied (step C1). Then, if the result of determination in step C1 is “Yes”, the coordinate sequence aggregation unit 30-f returns an empty set. Note that [l_{π},u_{π}] denotes the range of integers that start with the prefix n.

On the other hand, if the result of determination in step C1 is “No”, the coordinate sequence aggregation unit determines whether or not [l_{π}, u_{π}]⊂[l_{qf}, u_{qf}] is satisfied (step C2). Note that [l_{π},u_{π}] denotes the range of integers that start with the prefix π.

If the result of determination in step C2 is “Yes”, i.e. if [l_{π}, u_{π}]⊂[l_{qf}, u_{qf}] is satisfied, the range of coordinate values is included in the query range. Therefore, the coordinates included in P_{f}(π) [s, e] invariably belong to points included in the query. Therefore, the coordinate sequence aggregation unit 30-f executes the function “aggregate_node(v, s, e)” and returns the output result. The function “aggregate_node(v, s, e)” is a function that returns, with respect to the coordinate sequence P_{f}(π) corresponding to v, the statistical amount of the set of points to which the coordinates included in P_{f}(π) [s, e] belong.

On the other hand, if the result of determination in step C2 is “No”, the coordinate sequence aggregation unit 30-f calculates the interval [s_{left}, e_{left}] between the indices of the left child node and the interval [s_{right}, e_{right}] between the indices of the right child node, using the four expressions regarding “rank” shown in FIG. 8, where Bᵥ denotes the bit sequence retained by the node v (step C3).

By using these expressions, based on the characteristics of the wavelet tree, it is possible to calculate the interval [s_{left}, e_{left}] in the coordinate subsequence P_{f}(π_{left}) corresponding to the left child node and the interval [s_{right}, e_{right}] in the coordinate subsequence P_{f}(π_{right}) corresponding to the right child node, including the coordinates extracted from the interval [s, e] in the coordinate subsequence P_{f}(π) corresponding to the node v. Note that π_{left} and π_{right} are generated by expanding the prefix n by one. π_{left} corresponds to π+“0” and π_{right} corresponds to π+“1”.

Thereafter, in order to perform the same processing on the right child node and the left child node, the coordinate sequence aggregation unit 30-f recursively calls the following function.

return aggregate_interval (v_{left}, s_{left}, e_{left}, l_{qf}, u_{qf})∪aggregate_interval (v_{right}, s_{right}, e_{right}, l_{qf}, u_{qf})

### Step C2

Next, a function “aggregate_node(v, s, e)” that is called in step C2 shown in FIG. 8 will be described. This function is executed by the coordinate sequence aggregation unit 30.

The function “aggregate_node(v, s, e)” is a function that returns, with respect to the coordinate sequence P_{f}(π) corresponding to the node v, the statistical amount of the set of points to which the coordinates included in P_{f}(π) [s, e] belong.

The function “aggregate_node(v, s, e)” is an abstraction of various aggregation functions, and it is possible to use the information processing device 100 to perform various kinds of orthogonal range search by replacing this function with a specific aggregation function.

For example, the information processing device 100 is able to count and output the number of points included in the query region Q. This operation is realized by the function “aggregate_node(v, s, e)” returning e−s+1 as a return value. This is because all of the coordinates included in P_{f}(π)[s,e] respectively correspond to points included in the query region Q, and it is shown that e−s+1 points are included in the query region Q.

Also, at this time, the function “aggregate_interval(v, s, e, l_{qf}, u_{qf}” further operates as a function that counts and returns the number of points included in the query region Q out of the points whose coordinates are included in P_{f}[s, e]. In this case, the aggregation unit 20 counts the number of points included in the query region Q out of the points included in the sequence P of points.

Also, for example, if all of the points p are given a weight w(p), the information processing device 100 can calculate the sum of the weights of the points included in the query region. It is possible to realize the above operation in the case where a sequence W_{f}(π) obtained by arranging the weights w(p) of the corresponding points p in the same order has been set for each of the coordinates in every coordinate subsequence P_{f}(π), if a data structure that allows for calculating the total weights of the intervals in the sequence has been prepared.

An example of such a data structure is an existing data structure that handles “Partial Sum”. In the case of such a data structure, if it is known that the interval P_{f}(π)[s, e] corresponds to the points included in the query region, it is possible to calculate the sum of the weights of all of the points included in the query region Q by calculating the total weight in each interval W_{f}(π)[s, e] in the sequence of weights corresponding to the interval [s,e], and sum the total weights. If this is the case, the aggregation unit 20 outputs the total of the weights of all of the points included in the query region Q as the statistical amount.

Similarly, the information processing device 100 may be used as a report query that returns a list of every point included in the query region Q. In other words, with respect to the interval P_{f}(π)[s,e] in a coordinate subsequence, it is possible to specify the positions i, in the original integer sequence P_{f}, of the elements P_{f}(π)[j] included in this interval by tracing back the wavelet tree. In this case, the points P[i] are included in the query region. If this is the case, the aggregation unit 20 outputs a list of every point included in the query region Q as the statistical amount.

This concludes the description of the function “aggregate_interval(v, s, e, l_{qf}, u_{qf})” and the function “aggregate_node(v, s, e)”. Note that the operations of these two functions are equivalent to the calculation of statistical amounts in a two-dimensional space using the wavelet tree shown in Non-Patent Document 2. In other words, the operations of these two functions can be considered as a search in a two-dimensional space with the interval [s, e] between indices and the range [l_{qf}, u_{qf}] of the value being specified. It is known that the number of intervals that can be obtained by this calculation is O(log n).

As described above, according to the present embodiment, it is possible to realize various kinds of an orthogonal range search. Also, the present embodiment is not limited to a mode in which the algorithms shown in FIGS. 6 to 8 are individually used, and may be a mode in which other search algorithms are combined with the algorithms shown in FIGS. 6 to 8 as appropriate.

### Effects of Embodiment

The present embodiment has an effect in that time complexity is lower than in the case of a conventional approach using a k-d tree. To show this fact, the worst time complexity will be analyzed. A conventional approach using a k-d tree is an approach by which division is performed until the inclusive dimension number reaches d, whereas the present embodiment is an approach by which division is performed until the inclusive dimension number reaches d−1. The following describes the effect on the worst time complexity caused by this fact.

First, the number of divisions of nodes of the k-d tree in the case of the worst time complexity is estimated. The time complexity is the worst when the number of spatial divisions is at the maximum. In other words, the time complexity is the worst when the two coverage regions generated by division performed once always overlap the query region.

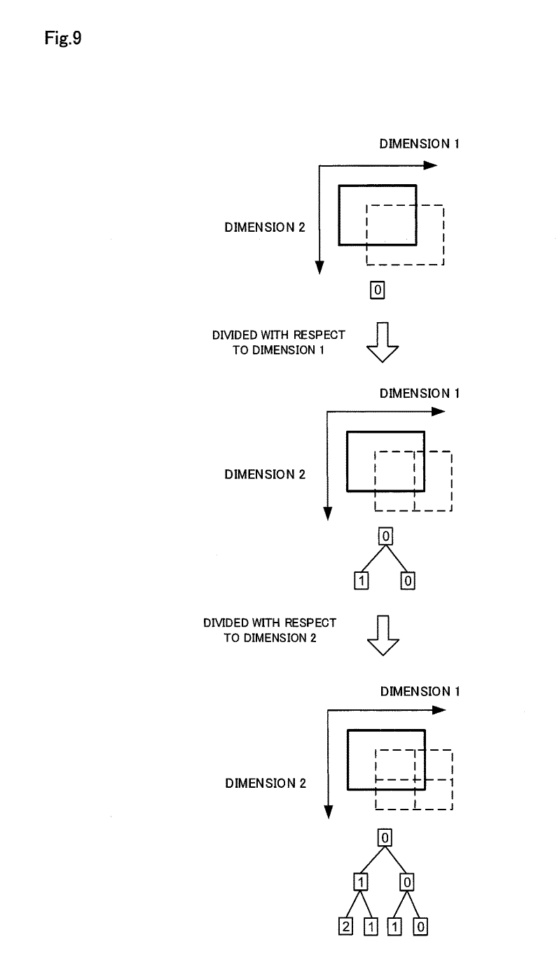

FIG. 9 shows the relationship between the number of search nodes and the inclusive dimension number in the worst case. FIG. 9 is a diagram showing changes in the number of search nodes and the inclusive dimension number in a two-dimensional case. As shown in FIG. 9, one node in the tree structure corresponds to one search node. When the depth in the tree structure increases by one, the node is divided once, into two search nodes. The numbers on the nodes show the inclusive dimension numbers. It can be seen that the number of nodes whose inclusive dimension number is high increases as division is performed.

Here, division performed d times is considered as one set. A recursive formula that is true between Tₕ(m) and Tₕ(m−1) will be considered, where Tₕ(m) denotes the number of nodes whose inclusive dimension number is h at a depth of m*d. If division is performed d times, one coverage region is divided into 2d coverage regions. In this regard, the coverage region is invariably divided once with respect to each dimension. The inclusive dimension number does not increase even if division is performed with respect to a dimension that is already included. Therefore, in order to calculate the number of nodes whose inclusive dimension number is h at a depth of m*d, the number with which h−i dimensions are newly included with respect to the nodes whose inclusive dimension number is i(≦h) at a depth of (m−1)*d is to be considered.

This recursive formula is as shown in Math. 1 below. Note that C(x,y) in Math. 1 below shows the number of combinations.

$$\\ \begin{matrix}{T}_{h} ( m ) = {\sum }_{i = 0}^{h} {2}^{i} C ( d - i , h - i ) {T}_{i} ( m - 1 ) \\ = \begin{matrix}{2}^{h} {T}_{h} ( m - 1 ) - {2}^{h - 1} ( d - h + 1 ) {T}_{h - 1} ( m - 1 ) + … + \\ {T}_{0} ( m - 1 )\end{matrix}\end{matrix} \qquad Math . 1$$

From the above Math. 1, it can be seen that the total number of nodes increases by 2^{d} times when division is performed d times, and among these nodes, the number of nodes whose inclusive dimension number is h increases by 2^{h} times.

As a result of such division being repeated log(n)/d times, the search tree as a whole becomes a binary tree having a depth of log n, and the total number of nodes reaches O(n), and division is complete. Among these nodes, the number of nodes whose inclusive dimension number is h is O(n^{(h/d)}). Note that the number of nodes whose inclusive dimension number is 0 is O(log n).

Therefore, the following description is true. First, if the search is not terminated at all, the number of divisions is O(n) at maximum. If the division is terminated when the inclusive dimension number reaches d, the number of divisions is O(n^{(d-1)/d}). If the division is terminated when the inclusive dimension number reaches d−1, the number of divisions is O(n^{(d-2)/d}). According to the k-d tree, the division is terminated when the inclusive dimension number reaches d, and therefore the time complexity is O(n^{(d-1)/d}). This matches the conventionally known order.

This analysis of a k-d tree is applied to the present embodiment. According to the present embodiment, the division is terminated when the inclusive dimension number reaches d−1, and therefore, the number of divisions, i.e. the number of intervals calculated by using the k-d tree, is O(n^{(d-2)/d}) at maximum.

The function “aggregate_interval(v, s, e, l_{qf}, u_{qf})” is executed for each interval. In this function, the function “aggregate_node(v, s, e)” is executed O(log n) times. Here, it is assumed that the function “aggregate_node(v, s, e)” is a function that can be executed with O(1). For example, the count query can be realized by simply calculating e−s+1, and therefore the calculation can be realized with O(1). Therefore, in the approach according to the present embodiment, the calculation with O(1) is performed O(log n) times with respect to each of O(n^{(d-2)/d}) intervals, and the total time complexity is O(n^{(d-2)/d} log n).

However, the case in which d=2 is satisfied is a special case. The search loop is terminated when d−1=1 dimension is included, and therefore the number of divided nodes is proportional to O(log n), which is the number of nodes whose inclusive dimension number is 0. The time complexity of each node is O(log n), and therefore the total time complexity when d=2 is O(log² n).

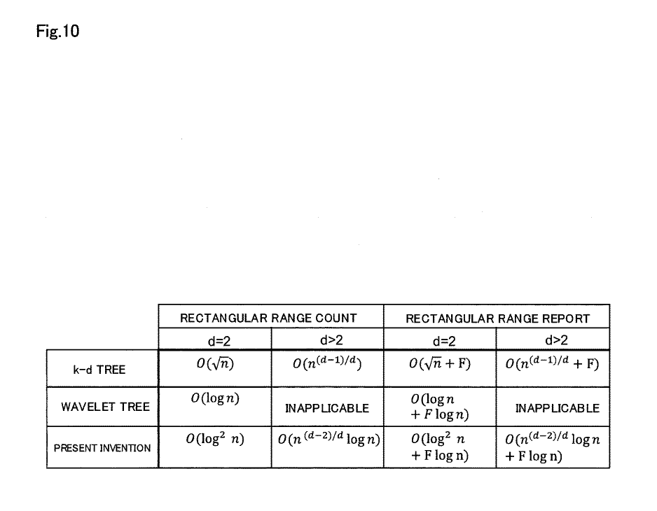

The above description is of the case of a count query for outputting the number of points included in the query region. In the case of a report query for outputting a list of every included point, the computation time of each F point that is to be output is O(log n). FIG. 10 is a summary. As shown in FIG. 10, the present invention improves the order of time complexity compared to search processing performed using a k-d tree, and furthermore, unlike conventional wavelet trees, the present invention is applicable to case where the number of dimensions is three or more. FIG. 10 is a diagram showing a comparison between the present invention and a conventional approach in terms of time complexity.

### Program

A program according to the embodiment of the present invention may be a program that causes a computer to execute the steps A1 to A10 shown in FIG. 6. The information processing device 100 and the information processing method according to the present embodiment can be realized by installing this program to a computer and executing the program. If this is the case, the CPU (Central Processing Unit) of the computer functions as the interval search unit 10, the aggregation unit 20, the coordinate sequence aggregation unit 30, the input receiving unit 50, and the output unit 60, and performs processing. Also, in the present embodiment, the storage unit 43 is realized by storing data files that constitute these units in a storage device provided for the computer, such as a hard disk.

Note that the program according to the present embodiment may be executed by a computer system that is built including a plurality of computers. If this is the case, for example, the computers may respectively function as the search unit 10, the aggregation unit 20, the coordinate sequence aggregation unit 30, the input receiving unit 50, and the output unit 60. Also, the storage unit 43 may be built in a computer that is different from the computer that executes the program according to the present embodiment.

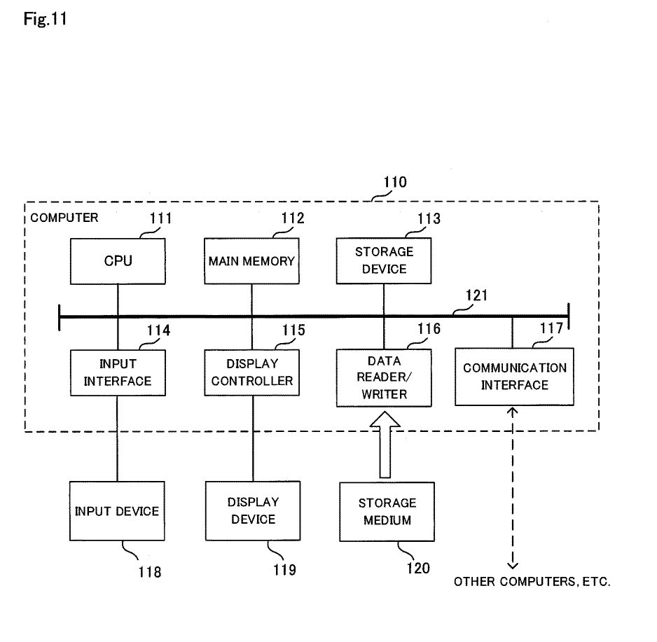

Here, a computer that realizes the information processing device 100 by executing the program according to the present embodiment will be described with reference to FIG. 11. FIG. 11 is a block diagram showing an example of a computer that realizes the information processing device according to the embodiment of the present invention.

As shown in FIG. 11, a computer 110 includes a CPU 111, a main memory 112, a storage device 113, an input interface 114, a display controller 115, a data reader/writer 116, and a communication interface 117. These units are connected to each other via a bus 121 such that data communication can be performed therebetween.

The CPU 111 loads, to the main memory 112, the program (code) according to the present embodiment stored in the storage device 113, and executes the program in a predetermined order to perform various kinds of computation. Typically, the main memory 112 is a volatile storage device such as a DRAM (Dynamic Random Access Memory). The program according to the present embodiment is provided in a state of being stored in a computer-readable storage medium 120. The program according to the present embodiment may be distributed through the internet connected via the communication interface 117.

Specific examples of the storage device 113 include, in addition to a hard disk drive, a semiconductor storage device such as a flash memory. The input interface 114 mediates data transmission between the CPU 111 and an input device 118 such as a keyboard or a mouse. The display controller 115 is connected to a display device 119, and controls display on the display device 119.

The data reader/writer 116 mediates data transmission between the CPU 111 and the storage medium 120, reads the program from the storage medium 120, and writes the results of processing by the computer 110 to the storage medium 120. The communication interface 117 mediates data transmission between the CPU 111 and other computers.

Specific examples of the storage medium 120 include a general-purpose semiconductor storage device such as a CF (Compact Flash™) and an SD (Secure Digital), a magnetic storage medium such as a Flexible Disk, and an optical storage medium such as a CD-ROM (Compact Disk Read Only Memory).

Although part or all of the above-described embodiment can be expressed by Supplementary Notes 1 to 28 described below, the present invention is not limited to the description.

Supplementary Note 1: An information processing device that processes a data structure that expresses a set of points that are included in a multidimensional space, comprising:

an interval search unit that, when a particular multidimensional region is specified as a query region, specifies an interval that is included in a sequence of points that is obtained by arranging the set of points in a sequence, and that is composed of only points whose coordinates with respect to dimensions other than one dimension, out of all dimensions that constitute the multidimensional space, are included in the query region;

an aggregation unit that specifies, with respect to the interval specified by the interval search unit, a range of coordinate values with respect to the one dimension, as a condition for a point that appears in the interval to be included in the query region; and

a coordinate sequence aggregation unit that receives the interval specified by the interval search unit and the range of a coordinate value specified by the aggregation unit, and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculates a statistical amount regarding a set of points to which the coordinates correspond.

Supplementary Note 2: The information processing device according to Supplementary Note 1,

wherein the coordinate sequence aggregation unit is provided for each of the dimensions that constitute the multidimensional space, and each coordinate sequence aggregation unit calculates the statistical amount regarding the set of points when the corresponding dimension coincides with the dimension for which the aggregation unit has specified the range of coordinate value.

Supplementary Note 3: The information processing device according to Supplementary Note 1,

wherein, when a plurality of intervals are specified by the interval search unit, the aggregation unit further aggregates statistical amounts regarding the set of points of the intervals, calculated by the coordinate sequence aggregation unit, and outputs the statistical amount obtained by the aggregation as an overall statistical amount regarding a set of points that are included in the query region.

Supplementary Note 4: The information processing device according to Supplementary Note 1,

wherein the data structure includes a first data structure that is used by the interval search unit to specify the interval, and a second data structure that is used by the coordinate sequence aggregation unit to calculate the statistical amount.

Supplementary Note 5: The information processing device according to Supplementary Note 4,

wherein the first data structure is expressed as a tree structure that has nodes that are each associated with: any of a plurality of coverage regions that are set in the multidimensional space; and an interval that is included in the sequence of points and in which a point that is included in the corresponding coverage region appears, and

the interval search unit specifies, from among the nodes, one or more nodes for which coordinates of points that are included in the coverage regions associated thereto, with respect to the dimensions other than the one dimension, are included in the query region, and specifies, as the interval, intervals that are associated with the one or more nodes thus specified.

Supplementary Note 6: The information processing device according to Supplementary Note 5,

wherein the sequence of points is obtained by arranging points that are included in the set of points in a sequence such that the points that are included in the coverage regions associated with the nodes appear in series.

Supplementary Note 7: The information processing device according to Supplementary Note 4,

wherein the coordinate sequence aggregation unit specifies, from among a plurality of subsequences that are obtained from the coordinate sequence, a subsequence in which only coordinates that are included in the input range appear, by using the second data structure, then specifies a second interval that is an interval in the subsequence thus specified and in which coordinates that appear in the input interval in the coordinate sequence appear, and calculates the statistical amount regarding the set of points to which the coordinates that appear in the second interval thus specified correspond.

Supplementary Note 8: The information processing device according to Supplementary Note 7,

wherein the subsequence is obtained by extracting coordinates whose bit representations start with the same prefix, while maintaining a positional relationship between the coordinates,

the second data structure has a plurality of nodes that are associated with the subsequence, and each of the plurality of nodes is expressed by using a bit sequence that is obtained by taking out one or more bits at a particular digit from respective bit representations of coordinates that appear in the subsequence, and arranging the bits in an order that is the same as an order of the subsequence, and

the coordinate sequence aggregation unit specifies the second interval by using bit sequences that respectively express the plurality of nodes.

Supplementary Note 9: The information processing device according to Supplementary Note 1,

wherein the coordinate sequence aggregation unit calculates the number of points to which all of the coordinates correspond, as the statistical amount regarding the set of points to which all of the coordinates correspond.

Supplementary Note 10: The information processing device according to Supplementary Note 1,

wherein the coordinate sequence aggregation unit calculates coordinates of points to which all of the coordinates correspond, with respect to each of the dimensions, as the statistical amount regarding the set of points to which all of the coordinates correspond.

Supplementary Note 11: An information processing method for processing a data structure that expresses a set of points that are included in a multidimensional space, comprising:

(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;

(b) a step of specifying, with respect to the interval specified in the step (a), a range of coordinate values with respect to the one dimension, as a condition for a point that appears in the interval to be included in the query region; and

(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculating a statistical amount regarding a set of points to which the coordinates correspond.

Supplementary Note 12: The information processing method according to Supplementary Note 11, further comprising:

(d) a step of, when a plurality of intervals are specified in the step (a), further aggregating a statistical amount regarding the set of points for each interval calculated in the step (b), and outputting the statistical amount obtained by the aggregation as an overall statistical amount regarding a set of points that are included in the query region.

Supplementary Note 13: The information processing method according to Supplementary Note 11,

wherein the data structure includes a first data structure that is used in the step (a) to specify the interval, and a second data structure that is used in the step (c) to calculate the statistical amount.

Supplementary Note 14: The information processing method according to Supplementary Note 13,

wherein the first data structure is expressed as a tree structure that has nodes that are each associated with: any of a plurality of coverage regions that are set in the multidimensional space; and an interval that is included in the sequence of points and in which a point that is included in the corresponding coverage region appears, and

in the step (a), one or more nodes for which coordinates of points that are included in the coverage regions associated thereto, with respect to the dimensions other than the one dimension, are included in the query region are specified from among the nodes, and, as the interval, intervals that are associated with the one or more nodes thus specified are specified.

Supplementary Note 15: The information processing method according to Supplementary Note 14,

wherein the sequence of points is obtained by arranging points that are included in the set of points in a sequence such that the points existing in the coverage regions associated with the nodes appear in series.

Supplementary Note 16: The information processing method according to Supplementary Note 13,

wherein, in the step (c), from among a plurality of subsequences that are obtained from the coordinate sequence, a subsequence in which only coordinates that are included in the input range appear is specified by using the second data structure, then a second interval that is an interval in the subsequence thus specified and in which coordinates that appear in the input interval in the coordinate sequence appear is specified, and a statistical amount regarding the set of points to which the coordinates that appear in the second interval thus specified correspond is calculated.

Supplementary Note 17: The information processing method according to Supplementary Note 16,

wherein the subsequence is obtained by extracting coordinates whose bit representations start with the same prefix, while maintaining a positional relationship between the coordinates,

the second data structure has a plurality of nodes that are associated with the subsequence, and each of the plurality of nodes is expressed by using a bit sequence that is obtained by taking out one or more bits at a particular digit from respective bit representations of coordinates that appear in the subsequence, and arranging the bits in an order that is the same as an order of the subsequence, and

in the step (c), the second interval is specified by using bit sequences that respectively express the plurality of nodes.

Supplementary Note 18: The information processing method according to Supplementary Note 11,

wherein, in the step (c), the number of points to which all of the coordinates correspond is calculated as the statistical amount regarding the set of points to which all of the coordinates correspond.

Supplementary Note 19: The information processing method according to Supplementary Note 11,

wherein, in the step (c), coordinates of points to which all of the coordinates correspond are calculated with respect to each of the dimensions, as the statistical amount regarding the set of points to which all of the coordinates correspond.

Supplementary Note 20: A computer-readable storage medium that stores a program for executing information processing to process a data structure that expresses a set of points that are included in a multidimensional space by using a computer, the program including an instruction that causes the computer to execute:

(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;

(b) a step of specifying, with respect to the interval specified in the step (a), a range of coordinate values with respect to the one dimension, as a condition for a point that appears in the interval to be included in the query region; and

(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculating a statistical amount regarding a set of points to which the coordinates correspond.

Supplementary Note 21: The computer-readable storage medium according to Supplementary Note 20,

wherein the program further includes an instruction that causes the computer to execute:

(d) a step of, when a plurality of intervals are specified in the step (a), further aggregating a statistical amount regarding the set of points for each interval calculated in the step (b), and outputting the statistical amount obtained by the aggregation as an overall statistical amount regarding a set of points that are included in the query region.

Supplementary Note 22: The computer-readable storage medium according to Supplementary Note 20,

wherein the data structure includes a first data structure that is used in the step (a) to specify the interval, and a second data structure that is used in the step (c) to calculate the statistical amount.

Supplementary Note 23: The computer-readable storage medium according to Supplementary Note 22,

wherein the first data structure is expressed as a tree structure that has nodes that are each associated with: any of a plurality of coverage regions that are set in the multidimensional space; and an interval that is included in the sequence of points and in which a point that is included in the corresponding coverage region appears, and

in the step (a), one or more nodes for which coordinates of points that are included in the coverage regions associated thereto, with respect to the dimensions other than the one dimension, are included in the query region are specified from among the nodes, and, as the interval, intervals that are associated with the one or more nodes thus specified are specified.

Supplementary Note 24: The computer-readable storage medium according to Supplementary Note 23,

wherein the sequence of points is obtained by arranging points that are included in the set of points in a sequence such that the points existing in the coverage regions associated with the nodes appear in series.

Supplementary Note 25: The computer-readable storage medium according to Supplementary Note 22,

wherein, in the step (c), from among a plurality of subsequences that are obtained from the coordinate sequence, a subsequence in which only coordinates that are included in the input range appear is specified by using the second data structure, then a second interval that is an interval in the subsequence thus specified and in which coordinates that appear in the input interval in the coordinate sequence appear is specified, and a statistical amount regarding the set of points to which the coordinates that appear in the second interval thus specified correspond is calculated.

Supplementary Note 26: The computer-readable storage medium according to Supplementary Note 25,

wherein the subsequence is obtained by extracting coordinates whose bit representations start with the same prefix, while maintaining a positional relationship between the coordinates,

the second data structure has a plurality of nodes that are associated with the subsequence, and each of the plurality of nodes is expressed by using a bit sequence that is obtained by taking out one or more bits at a particular digit from respective bit representations of coordinates that appear in the subsequence, and arranging the bits in an order that is the same as an order of the subsequence, and in the step (c), the second interval is specified by using bit sequences that respectively express the plurality of nodes.

Supplementary Note 27: The computer-readable storage medium according to Supplementary Note 20,

wherein, in the step (c), the number of points to which all of the coordinates correspond is calculated as the statistical amount regarding the set of points to which all of the coordinates correspond.

Supplementary Note 28: The computer-readable storage medium according to Supplementary Note 20,

wherein, in the step (c), coordinates of points to which all of the coordinates correspond are calculated with respect to each of the dimensions, as the statistical amount regarding the set of points to which all of the coordinates correspond.

Although the present invention is described above with reference to an embodiment, the present invention is not limited to the embodiment. Those skilled in the art will appreciate that various modifications can be made to the configurations and details of the present invention within the scope of the present invention.

This application is based upon and claims priority to Japanese Patent Application No. 2014-227041, filed on Nov. 7, 2014, the disclosure of which is incorporated in its entirety herein by reference.

### INDUSTRIAL APPLICABILITY

As described above, according to the present invention, it is possible to realize an orthogonal range search with respect to a desired dimension d at a higher speed compared to cases of k-d trees, by using a data structure having a linear size. The present invention is useful in various fields in which necessary data needs to be searched for from among a large number of data sets.

### DESCRIPTIONS OF REFERENCE NUMERALS

10: Interval search unit
20: Aggregation unit
30, 30-1 to 30-d: Coordinate sequence aggregation unit
40: Data structure
41: Interval search data structure
42: Coordinate sequence aggregation data structure
43: Storage unit
50: Input receiving unit
60: Output unit
100: Information processing device
110: Computer
111: CPU
112: Main memory
113: Storage device
114: Input interface
115: Display controller
116: Data reader/writer
117: Communication interface
118: Input device
119: Display device
120: Storage medium
121: Bus

What is claimed is:

1. An information processing device that processes a data structure that expresses a set of points that are included in a multidimensional space, comprising:
an interval search unit that, when a particular multidimensional region is specified as a query region, specifies an interval that is included in a sequence of points that is obtained by arranging the set of points in a sequence, and that is composed of only points whose coordinates with respect to dimensions other than one dimension, out of all dimensions that constitute the multidimensional space, are included in the query region;
an aggregation unit that specifies, with respect to the interval specified by the interval search unit, a range of coordinate values with respect to the one dimension, as a condition for a point that appears in the interval to be included in the query region; and
a coordinate sequence aggregation unit that receives the interval specified by the interval search unit and the range of a coordinate value specified by the aggregation unit, and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculates a statistical amount regarding a set of points to which the coordinates correspond.

2. The information processing device according to claim 1,
wherein the coordinate sequence aggregation unit is provided for each of the dimensions that constitute the multidimensional space, and each coordinate sequence aggregation unit calculates the statistical amount regarding the set of points when the corresponding dimension coincides with the dimension for which the aggregation unit has specified the range of coordinate value.

3. The information processing device according to claim 1,
wherein, when a plurality of intervals are specified by the interval search unit, the aggregation unit further aggregates statistical amounts regarding the set of points of the intervals, calculated by the coordinate sequence aggregation unit, and outputs the statistical amount obtained by the aggregation as an overall statistical amount regarding a set of points that are included in the query region.

4. The information processing device according to claim 1,
wherein the data structure includes a first data structure that is used by the interval search unit to specify the interval, and a second data structure that is used by the coordinate sequence aggregation unit to calculate the statistical amount.

5. The information processing device according to claim 4,
wherein the first data structure is expressed as a tree structure that has nodes that are each associated with: any of a plurality of coverage regions that are set in the multidimensional space; and an interval that is included in the sequence of points and in which a point that is included in the corresponding coverage region appears, and
the interval search unit specifies, from among the nodes, one or more nodes for which coordinates of points that are included in the coverage regions associated thereto, with respect to the dimensions other than the one dimension, are included in the query region, and specifies, as the interval, intervals that are associated with the one or more nodes thus specified.

6. The information processing device according to claim 5,
wherein the sequence of points is obtained by arranging points that are included in the set of points in a sequence such that the points that are included in the coverage regions associated with the nodes appear in series.

7. The information processing device according to claim 4,
wherein the coordinate sequence aggregation unit specifies, from among a plurality of subsequences that are obtained from the coordinate sequence, a subsequence in which only coordinates that are included in the input range appear, by using the second data structure, then specifies a second interval that is an interval in the subsequence thus specified and in which coordinates that appear in the input interval in the coordinate sequence appear, and calculates a statistical amount regarding the set of points to which the coordinates that appear in the second interval thus specified correspond.

8. The information processing device according to claim 7,
wherein the subsequence is obtained by extracting coordinates whose bit representations start with the same prefix, while maintaining a positional relationship between the coordinates,
the second data structure has a plurality of nodes that are associated with the subsequence,
each of the plurality of nodes is expressed by using a bit sequence that is obtained by taking out one or more bits at a particular digit from respective bit representations of coordinates that appear in the subsequence, and arranging the bits in an order that is the same as an order of the subsequence, and
the coordinate sequence aggregation unit specifies the second interval by using bit sequences that respectively express the plurality of nodes.

9. The information processing device according to claim 1,
wherein the coordinate sequence aggregation unit calculates the number of points to which all of the coordinates correspond, as the statistical amount regarding the set of points to which all of the coordinates correspond.

10. The information processing device according to claim 1,
wherein the coordinate sequence aggregation unit calculates coordinates of points to which all of the coordinates correspond, with respect to each of the dimensions, as the statistical amount regarding the set of points to which all of the coordinates correspond.

11. An information processing method for processing a data structure that expresses a set of points that are included in a multidimensional space, comprising:
(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;
(b) a step of specifying, with respect to the interval specified in the step (a), a range of coordinate values with respect to the one dimension, as a condition for a point that appears in the interval to be included in the query region; and
(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculating a statistical amount regarding a set of points to which the coordinates correspond.

12.-19. (canceled)

20. A non transitory computer-readable storage medium that stores a program for executing information processing to process a data structure that expresses a set of points that are included in a multidimensional space by using a computer, the program including an instruction that causes the computer to execute:
(a) a step of, when a particular multidimensional region is specified as a query region, specifying an interval that is included in a sequence of points that is obtained by arranging the set of points in a sequence, and that is composed of only points whose coordinates with respect to dimensions other than one dimension, out of all dimensions that constitute the multidimensional space, are included in the query region;
(b) a step of specifying, with respect to the interval specified in the step (a), a range of coordinate values with respect to the one dimension, as a condition for a point that appears in the interval to be included in the query region; and
(c) a step of receiving the interval specified in the step (a) and the range of a coordinate value specified in the step (b), and, with respect to a coordinate sequence that is obtained by taking out coordinates of the set of points with respect to the one dimension in an order that is the same as an order in which the sequence of points are arranged, and with respect to all coordinates that appear in the input interval in the coordinate sequence and whose values are included in the input range, calculating a statistical amount regarding a set of points to which the coordinates correspond.

21.-28. (canceled)
